(19) United States
(12) Patent Application Publication
(10) Pub. No.: US 2009/0007248 A1
(43) Pub. Date: Jan. 1, 2009

(54) Single sign-on system and method

(76) Inventor: Michael Kovaleski, Anderson, IN (US)

Correspondence Address: BINGHAM MCHALE LLP, 2700 MARKET TOWER, 10 WEST MARKET STREET, INDIANAPOLIS, IN, 46204-4900, US

(21) Appl. No.: 12/009,594

(22) Filed: Jan. 18, 2008

Related U.S. Application Data
(60) Provisional application No. 60/885,580, filed on Jan. 18, 2007.

(51) Int. Cl. H04L 9/32; G06F 21/00

(52) U.S. Cl. 726/8

(57) ABSTRACT

A single sign-on (SSO) provider establishes a system by which users authenticate once per session with the provider, then can access multiple sites that require credentials without manually supplying or remembering those other credentials. A browser plug-in on the user's terminal accesses the SSO provider's resources and retrieves relevant credentials for the user's session. The SSO provider contracts with a third-party administrator (TPA) of medical and/or insurance benefits, and provides SSO accounts individuals served by the TPA (usually employees of the TPA's clients). These accounts may be pre-loaded with links to (and even credentials for logging into) network-accessible resources relating to the individuals' insurance and/or medical care. Additional links and credentials might be preloaded based on the goodwill of the SSO provider or affiliate contracts, and the individuals might be enabled to add further links and credentials.

### REFERENCE TO RELATED APPLICATION

This application claims the benefit of U.S. Provisional Patent Application 60/885,580, filed Jan. 18, 2007, with title SINGLE SIGN-ON SYSTEM AND METHOD.

### REFERENCE TO COMPUTER PROGRAM LISTING APPENDIX

A Computer Program Listing Appendix accompanies this specification and is incorporated by reference as if fully set forth herein.

### FIELD

The present invention relates to information security. More specifically, the present invention relates to a system using a single credential to access a plurality of systems or resources.

### BRIEF DESCRIPTION OF THE DRAWINGS

FIG. 1 is a diagram of the communications network in which one embodiment operates.

FIG. 2 is a block diagram of a computing device for use in any of a variety of roles in embodiments of the present invention.

FIG. 3 is a diagram illustrating relationships among entities participating in another embodiment.

FIG. 4 is a flowchart illustrating use by a subject of single sign-on services in another embodiment.

FIG. 5 is a flowchart showing provision of single sign-on services in a business relationship with a third-party administrator of insurance services.

### DESCRIPTION

For the purpose of promoting an understanding of the principles of the present invention, reference will now be made to the embodiment illustrated in the drawings and specific language will be used to describe the same. It will, nevertheless, be understood that no limitation of the scope of the invention is thereby intended; any alterations and further modifications of the described or illustrated embodiments, and any further applications of the principles of the invention as illustrated therein are contemplated as would normally occur to one skilled in the art to which the invention relates.

Generally, one form of the present invention is a single sign-on system for accessing networked information resources. In another embodiment, an SSO provider contracts with a third-party administrator (TPA) of medical and/or insurance services to make single sign-on services available to the insured individuals served by the TPA. The TPA appreciates its insureds being able to more efficiently access their insurance, benefit, and claim information, as well as other authoritative research sources. (Note that “clients” herein refers to clients of the SSO provider, not the direct clients of the TPA, which would be the employer the individual or an organization to which he or she belongs.) Further, in some situations this SSO arrangement allows the TPA to maintain contact with an individual even after their employment terminates.

Networked collection (system) 100 of resources in a first embodiment includes single sign-on (SSO) resource 110, authentication resource 120, client workstations 130 and 140, and networked information resource 150 are all connected to network 160, through which all communications in this embodiment flow unless otherwise specified. One such exception is storage resource 170, which is connected to SSO resource 110, but is not directly connected to network 160. This framework supports communications and relationships that are described herein.

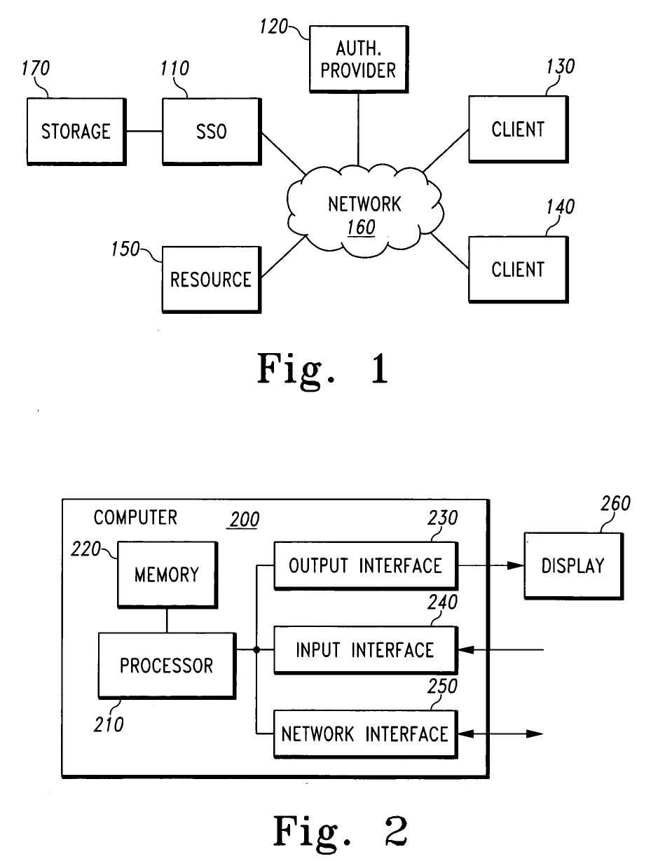

The computers used as servers, clients, resources, interface components, and the like for the various embodiments described herein generally take the form shown in FIG. 2. Computer 200, as this example will generically be referred to, includes processor 210 in communication with memory 220, output interface 230, input interface 240, and network interface 250. Power, ground, clock, and other signals and circuitry are omitted for clarity, but will be understood and easily implemented by those skilled in the art.

With continuing reference to FIG. 2, network interface 250 in this embodiment connects computer 200 a data network (such as to network 160) for communication of data between computer 200 and other devices attached to the network. Input interface 240 manages communication between processor 210 and one or more push-buttons, UARTs, IR and/or RF receivers or transceivers, decoders, or other devices, as well as traditional keyboard and mouse devices. Output interface 230 provides a video signal to display 260, and may provide signals to one or more additional output devices such as LEDs, LCDs, or audio output devices, or a combination of these and other output devices and techniques as will occur to those skilled in the art.

Processor 210 in some embodiments is a microcontroller or general purpose microprocessor that reads its program from memory 220. Processor 210 may be comprised of one or more components configured as a single unit. Alternatively, when of a multi-component form, processor 210 may have one or more components located remotely relative to the others. One or more components of processor 210 may be of the electronic variety including digital circuitry, analog circuitry, or both. In one embodiment, processor 210 is of a conventional, integrated circuit microprocessor arrangement, such as one or more CORE 2 QUAD processors from INTEL Corporation of 2200 Mission College Boulevard, Santa Clara, Calif. 95052, USA, or ATHLON or PHENOM processors from Advanced Micro Devices, One AMD Place, Sunnyvale, Calif. 94088, USA. In alternative embodiments, one or more application-specific integrated circuits (ASICs), general-purpose microprocessors, programmable logic arrays, or other devices may be used alone or in combination as will occur to those skilled in the art.

Likewise, memory 220 in various embodiments includes one or more types such as solid-state electronic memory, magnetic memory, or optical memory, just to name a few. By way of non-limiting example, memory 220 can include solid-state electronic Random Access Memory (RAM), Sequentially Accessible Memory (SAM) (such as the First-In, First-Out (FIFO) variety or the Last-In First-Out (LIFO) variety), Programmable Read-Only Memory (PROM), Electrically Programmable Read-Only Memory (EPROM), or Electrically Erasable Programmable Read-Only Memory (EEPROM); an optical disc memory (such as a recordable, rewritable, or read-only DVD or CD-ROM); a magnetically encoded hard drive, floppy disk, tape, or cartridge medium; or a plurality and/or combination of these memory types. Also, memory 220 is volatile, nonvolatile, or a hybrid combination of volatile and nonvolatile varieties.

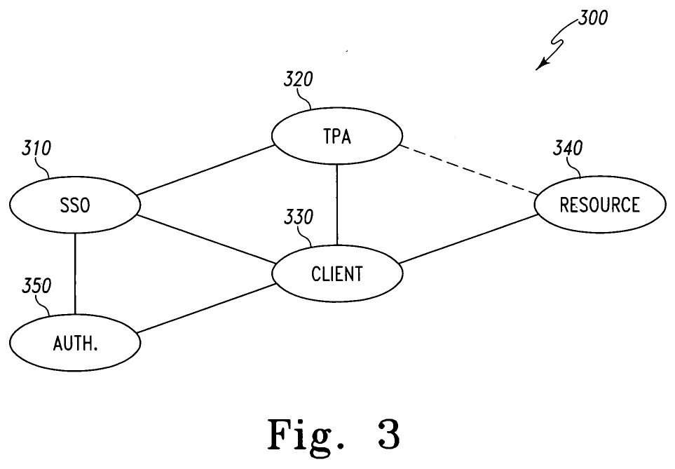

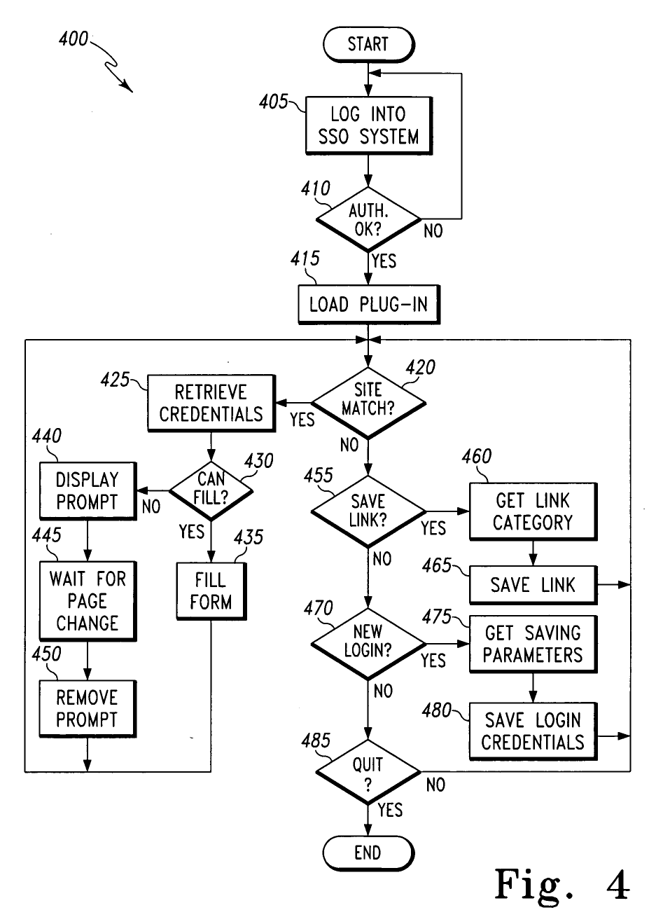

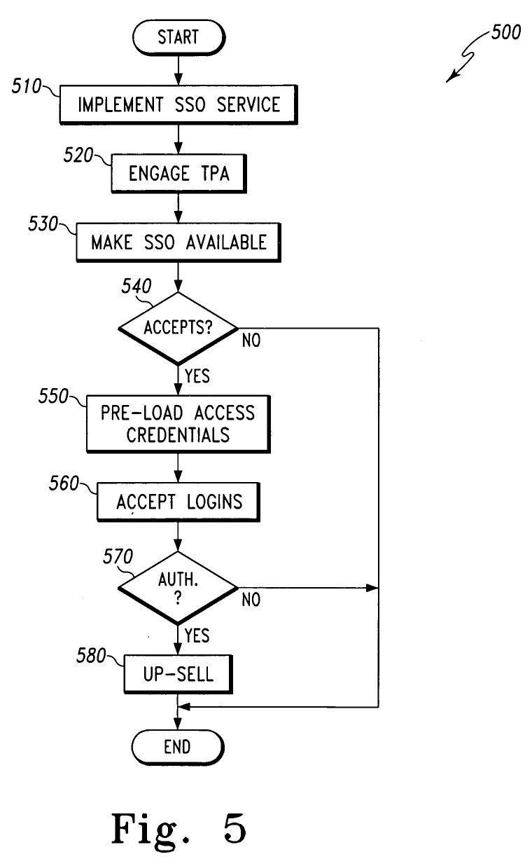

The relationships among the parties involved in these embodiments are illustrated as relationship network 300 in FIG. 3. SSO service provider 310 operates a SSO service by which users login a single time to a server of SSO provider 310, and software on the user's web browser facilitates the providing of credentials for many, many other websites. In this implementation, the resources shown in FIG. 1 are accessed using method 400, illustrated in FIG. 4. In method 400, a user begins to use the system at block 405 by providing login credentials to SSO resource 110 via a web browser. These credentials might involve a user name, password, another identifier (such as an email address or name), smart card (typically inserted into a smart card reader that is integrated in to or removably attached to a computer 200 at a client work station 130), biometric data acquisition, or other authentication technique as will occur to those skilled in the art. In this example, measurements of typing rhythm are transmitted to authentication provider 120 and checked against a stored rhythm profile for that user.

If the credentials provided and rhythm signature match in decision step 410, then access to that user's credentials for network resources 350 is enabled or facilitated by a browser plug-in, which is loaded at step 415. In other embodiments, other techniques are used for facilitating access to those other credentials, such as use of a freestanding application, a web browser with the system built in, or the like.

When access has been granted, the client-side software monitors browser activity and determines when the user has browsed to a website or other resource that matches the stored set of credentials. When that happens (a positive result at decision block 410), the system retrieves the credentials for that resource at block 425. The system determines whether it is capable of filling these credentials into a web form or other interface at decision block 430. If it can, the system fills the form at block 435 and returns to its monitoring activities.

If the system cannot fill the credentials into a form at a site (a negative result at decision block 430), such as if nonstandard or inaccessible technology is used (such as a Flash prompt, obscured or scripted forms, or the like), then at block 440 the system instead displays a prompt to the user showing the information that is to be provided to the resource. The system waits at block 445 for a page change, signifying that the user has either entered the credentials and they have been accepted, or the user has elected not to access this particular resource. After the page change, the prompt is removed from the user's screen at block 450, and the system resumes its monitoring.

If the current website has not triggered a retrieval (i.e., if we have a negative result in decision block 420), then the system checks whether the “save link” user interface element has been selected at decision block 455. If that interface element has been activated, then the system prompts the user at block 460 for a convenient name by which a link to the current page can be called and a category for the link so that retrieval can be expedited. The system saves the link at block 465 and returns to its monitoring tasks.

If the “save” interface element has not been activated, the system checks at decision block 470 whether a “new login” interface element has been activated. If so, the system acquires the same short name and category parameters from the user at block 475 and saves the login credentials at block 480. The system then returns to its monitoring.

Finally, if the “new login” user interface element was not selected, the system determines at decision block 485 using techniques known in the art whether the application is shutting down. If not, the system resumes its monitoring. If the system is shutting down, then method 400 ends.

Another embodiment will now be described with reference to the diagram in FIG. 3 and the flowchart of FIG. 5, illustrating method 500. Here SSO service provider 310 implements an SSO service (510) and develops a contractual relationship (520) with a third-party administrator (TPA) 320 of insurance and/or medical services. TPA 320 manages insurance services that are provided to its clients 330, including certain resources 340 available by network computer, such as websites that reflect account balances, claim status, coverage, and the like.

As part of the arrangement between SSO provider 310 and TPA 320, SSO provider 310 provides SSO services (530) to the client's 330 of TPA 320. If (540) a client 330 accepts these services explicitly, such as by signing a written agreement or accepting on-line terms of service, or implicitly, such as by using the service even after being presented with such terms of service, then a SSO account is created for him or her.

In this embodiment, TPA 320 and/or SSO service provider 310 pre-loads (550) the SSO service account of the client 330 with links to on-line resources 150 (see FIG. 1) made available by medical service providers and resources 340. In some embodiments, credentials for such client 330 are also pre-loaded into their account with SSO service provider 310 so that the client 330 can immediately use (560) the system to access his or her personalized information. In other embodiments, resources 340 other than those directly related to medical service providers affiliated with TPA 320 are pre-loaded into client accounts. (This is why the line between TPA 320 and resource provider 340 is dashed.) These might be “affiliate links” that provide additional revenue to SSO service provider 310, as will be well understood in the art, or they might be authoritative resources for medical, personal, or other information.

When a client 330 signs up with the service, part of the process of establishing the login credentials in this embodiment involves establishing a biometric profile with authentication provider 350, as well as more traditional login credentials with SSO service provider 310. Then, when the client 330 uses the system, initial authentication (570) is accomplished both with SSO service provider 310 and authentication service provider 350, and a combination of those authentication techniques must succeed in order for the user to gain access to the system.

In this embodiment, an authenticated client who accepts the account from SSO service provider 310 is offered (580) additional, “premium” service by SSO service provider 310 for some further consideration. For example, SSO service provider 310 offers new clients further options for credential storage that include the ability to add links to (and, optionally, credentials for) additional websites of the client's own arbitrary choosing. The consideration provided by the client 330 to the SSO service provider 310 in various embodiments includes a payment of money, installation of further software, or other consideration as will appear to those skilled in the art.

Another method provides subjects (i.e., SSO clients) with SSO access to multiple user ID and password-protected (as well as non-secure) websites. This SSO service may be used for ease of access on any computer that meets certain minimum requirements. Subjects can customize their SSO portals to include login pages from virtually any web application. For convenience, subjects can also include other websites that do not require user IDs and passwords. Thus, subjects are provided one web portal with SSO access to their entire personal list of websites to provide a more efficient and effective internet experience. Multiple subjects may even access their portals on the same computer. These different portals might contain the same websites or different ones, but the SSO system provides the different user logins even when the same site is listed under multiple subjects.

In some embodiments, the user's credentials are only displayed on the screen and are never stored locally on the user's terminal. This maintains some security against capture or retrieval, as will be understood by those skilled in the art.

In other embodiments, SSO services are marketed to associations, affinity groups, and employers. Some variations of these embodiments provide revenue to the association, group, or employer based on the purchase of additional services by users.

In still other embodiments, challenge questions-a series of personal questions and answers—are obtained from the user/subject during the initial SSO login process. These are used to authenticate the user if other authentication methods fail.

In yet other embodiments, more two-way authentication techniques are also used, such as “image and phrase key site validation,” as will be understood by those skilled in the art. These techniques present users with a certain image, often selected by the user, as an indication that the site they are using is actually the real SSO provider. A user-selected or user-entered word or phrase is displayed with the image as further assurance.

It is noted that in the described embodiments, the database of user credentials is stored in storage 170, as illustrated in FIG. 1. This storage device has no direct exposure to network 160, and is not directly accessible to client workstations 130, 140 or other devices. Even within the database, SSO data in these embodiments is hashed-password encrypted, and the password restoration signals are salted, rendering the raw user name and password data useless if compromised. Of course, other encryption systems are employed in other embodiments as will occur to those skilled in the art.

In some variations on these embodiments, the monitoring in method 400 does not include monitoring of browser activity. Instead, presentation and/or filling of credentials on web pages is triggered by affirmative selection of login links from a link page organized by SSO provider 110 and presented to the user in response to a successful login to the SSO system.

One implementation of a plug-in according to an embodiment discussed above is according to the source code in the Computer Program Listing Appendix.

All publications, prior applications, and other documents cited herein are hereby incorporated by reference in their entirety as if each had been individually incorporated by reference and fully set forth. While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A single sign-on system, comprising a processor and a first memory in communication with the processor, the first memory storing programming instructions executable by the processor to:
accept authentication of a user of the single sign-on system via a network;
receive access credentials for a networked resource from a browser on a first terminal via the network;
store the access credentials in a second memory, the second memory being remote from the browser;
responsively to a user command issued at a second terminal having a monitor and running a browser, using the login credentials to access the networked resource, the using step being selected from the action group consisting of:
displaying the login credentials on the monitor of the second terminal, or
entering the login credentials into an authentication form on the browser running on the second terminal.

2. The system of claim 0, wherein the access credentials stored in the second memory are not directly accessible to the user.

3. The system of claim 0, wherein the first terminal and the second terminal are the same.

4. A method of doing business as a SSO service provider, comprising:
engaging a TPA, wherein
the TPA administers medical insurance services for a plurality of clients, the insurance services including services from a plurality of medical service providers;
the TPA makes a SSO service account available to each of the clients; and
if a client accepts the SSO service account, pre-loading the SSO service account of the clients with links to on-line resources of the plurality of medical service providers.

5. The method of claim 4, wherein the pre-loading also includes access credentials for at least one of the resources medical service providers.

6. The method of claim 4, wherein the SSO service provider stores the links and one or more access credentials in storage that is neither directly controlled by nor directly accessible by the clients.

7. The method of claim 4, wherein the client's access to the SSO credentials is authenticated using authentication services of an authentication provider other than the SSO service provider.

8. The method of claim 4, further comprising:
offering a premium service to a user in exchange for additional consideration;
if the user accepts the offer, accepting a command from the user to add an additional network resource to the resources linked from the user's SSO service account.

9. A digital medium encoded with programming instructions executable by a processor to:
interact with a user to authenticate the user;
after successful authentication, to grant the user access to a single sign-on system, this access comprising:
retrieving access credentials to a plurality of network-accessible resources operated by a plurality of third parties, the retrieving being from a server via a network;
facilitating entry of the access credentials, this facilitating being selected from the group consisting of
automatically filling an interactive electronic form with the access credentials; and
displaying the credentials to the user so that the user can enter the credentials into an interactive electronic form.

10. The medium of claim 9, wherein:
the retrieving of access credentials is performed by a first terminal; and
the retrieved credentials are not stored on any nonvolatile medium local to the first terminal.

11. The medium of claim 9, wherein the programming instructions are further executable by the processor to:
accept a user command to store an additional access credential for a particular network-accessible resource; and
transmit the additional access credential to the server via the network.

12. The medium of claim 11, wherein the additional access credential is encrypted prior to being transmitted.
